(19) United States
(12) Patent Application Publication
(10) Pub. No.: US 2019/0313851 A1
(43) Pub. Date: Oct. 17, 2019

(54) Collapsible Smoke Minimizing Fire Pit

(71) Applicant: Dal Shemp, Pahrump, NV (US)

(72) Inventor: Dal Shemp, Pahrump, NV (US)

(21) Appl. No.: 16/382,870

(22) Filed: Apr. 12, 2019

Related U.S. Application Data
(60) Provisional application No. 62/658,510, filed on Apr. 16, 2018.

(51) Int. Cl. A47J 37/07; F23B 20/00

(52) U.S. Cl. CPC A47J 37/0718; A47J 2037/0777; F23B 20/00

(57) ABSTRACT

A collapsible smoke reducing fire pit comprises a combustion barrel with an open end and a base end, a locking lid with ash screen, an insulated ash container with heat shield, a folding leg assembly, and a component mount for items such as an attachable grill. The collapsible smoke reducing fire pit is designed to be portable and collapsible with the insulated ash container and folding leg assembly being able to fit inside the combustion barrel for storage and transportation. It is further designed to promote efficient combustion, reduce and prevent the ejection of embers, provide for the efficient collection and disposal of ashes, and conduct heat in such a way so as to prevent burning of objects around and beneath the fire pit.

### CROSS-REFERENCE TO RELATED APPLICATIONS

The present utility patent application claims priority benefit of the U.S. provisional application for patent Ser. No. 62/658,510 titled “Smoke Minimizing Fire Pit” filed on Apr. 16, 2018 under 35 U.S.C. 119(e). The contents of this related provisional application are incorporated herein by reference for all purposes to the extent that such subject matter is not inconsistent herewith or limiting hereof.

### RELATED CO-PENDING U.S. PATENT APPLICATIONS

Not applicable.

### FEDERALLY SPONSORED RESEARCH OR DEVELOPMENT

Not applicable.

### REFERENCE TO SEQUENCE LISTING, A TABLE, OR A COMPUTER LISTING APPENDIX

Not applicable.

### COPYRIGHT NOTICE

A portion of the disclosure of this patent document contains material that is subject to copyright protection. The copyright owner has no objection to the facsimile reproduction by anyone of the patent document or patent disclosure as it appears in the Patent and Trademark Office, patent file or records, but otherwise reserves all copyright rights whatsoever.

### BACKGROUND OF THE INVENTION

### 1. Field of the Invention

The invention relates generally to the field of fire enclosures. More specifically, the present invention relates to a collapsible smoke minimizing fire pit designed to increase combustion efficiency, reduce smoke, and prevent the dispersion of potentially hazardous embers.

### 2. Description of the Related Art

The role of fire in human history is widely understood. For early humans, fire provided the light necessary to extend a work day. Fire provided heat, and it facilitated cooking. Fire helped with hunting while warding off predators and insects alike. Throughout the years, sitting around a fire has given people a sense of security while providing a socially inviting environment.

Traditionally, people created fire pits by digging a hole in the ground or by creating enclosures with readily available materials such as rocks or mud. Such enclosures served to facilitate the starting of a fire, to contain the fire once ignited, to prevent the fire from spreading, and to provide a means for propagating light, distributing heat and for cooking food. Over the years, fire pits have evolved into modern fireplaces, wood burning stoves and various other outdoor adaptations such as barbecue grills and portable fire pits.

Barbecue grills have been available in a variety of types, sizes and shapes for decades. Such grills generally utilize charcoal or a compressed gas, such as propane, as a heat source. Small grills can be used on a table top such as a picnic table, while larger grills generally have integrated into their design wheels, legs and a stand or have a cart assembly that supports them at a comfortable height convenient for cooking food. Some units may have two to four wheels that make unit mobile by an individual. And though widely used and commercially successful, many people prefer the sense of being around and cooking over a more traditional campfire.

Recently, portable outdoor fire pits have offered the public an alternative to barbecue grills as well as traditional campfire enclosures. The portable outdoor fire pit offers users the feel and utility of a traditional wood-burning campfire while offering a more portable system which provides a generally safer operating environment than traditional campfires. Generally, the size of a portable outdoor fire pit is compact, relative to a fixed fireplace, and its structure is such that a portable outdoor fire pit can be readily and easily moved from one location to another either alone or with the assistance of at least one other individual. Many portable outdoor fire pits consist of nothing more than a large metal bowl and a stand on which to place the bowl.

The use of portable outdoor fire pits has presented myriad problems. The design of many portable fire pits does not provide for efficient combustion of fuels, thereby creating hazardous byproducts such as smoke and embers. Additionally, the design of many portable fire pits does not provide a means for the collection and disposal of the end products of combustion, namely ashes. Furthermore, many portable outdoor fire pits are designed in such a way that heat is distributed in a manner which may damage surfaces such as lawns or tabletops. Finally, many portable outdoor fire pits are only minimally collapsible, making them difficult to transport to and from outdoor locations.

It is clear that there exists a need for a smoke minimizing fire pit that is portable, customizable, promotes efficient combustion, reduces and prevents the ejection of embers, provides for the efficient collection and disposal of ashes, and conducts heat in such a way so as to prevent burning of objects around and beneath the fire pit.

### SUMMARY

The object of the present invention is to provide a collapsible smoke minimizing fire pit that is portable, customizable, promotes efficient combustion, reduces and prevents the ejection of embers, provides for the efficient collection and disposal of ashes, and conducts heat in such a way so as to prevent burning of objects around and beneath the fire pit.

At its essence, the smoke minimizing fire pit includes a combustion barrel, a locking lid with ash screen, a funnel-shaped ash channel, an insulated ash container with a heat shield, a folding steel leg assembly with stake holes, and a component mount for adding on components such as, but not limited to, a height-adjustable grill. Such an assembly provides for a user to easily and safely prepare a fire, safely maintain a fire, safely empty the byproduct ashes, and to collapse and store the collapsible smoke minimizing fire pit when finished.

### BRIEF DESCRIPTION OF THE DRAWINGS

Unless otherwise indicated illustrations in the figures are not necessarily drawn to scale. The invention directed by way of example, and not by way of limitation, in the figures of the accompanying drawings and in which like reference numerals refer to similar elements and in which:

FIG. 1 illustrates a perspective view of an exemplary collapsible smoke minimizing fire pit in accordance with an embodiment of the invention.

FIG. 2 is a side elevation view of the collapsible smoke minimizing fire pit in accordance with an embodiment of the invention.

FIG. 3 is a side exploded view of a collapsible smoke minimizing fire pit in accordance with an embodiment of the invention.

FIG. 4 is a side sectional view of a collapsible smoke minimizing fire pit in accordance with an embodiment of the invention.

FIG. 5 is a side cross sectional view of the combustion barrel and insulated ash container with heat shield of a collapsible smoke minimizing fire pit in accordance with an embodiment of the invention.

FIG. 6 is a top perspective view of the combustion chamber of the smoke minimizing fire pit in accordance with an embodiment of the invention.

FIG. 7 is a bottom perspective view of the combustion barrel of the smoke minimizing fire pit in accordance with an embodiment of the invention.

FIG. 8 is a perspective view of the insulated ash container with a heat shield of the collapsible smoke minimizing fire pit in accordance with an embodiment of the invention.

### DETAILED DESCRIPTION OF THE PREFERRED EMBODIMENTS

Terminology used herein is used for the purpose of describing particular embodiments only, and is not intended to limit the scope of the present invention. It must be understood that as used herein and in the appended claims, the singular forms “a,” “an,” and “the” include the plural reference unless the context clearly dictates otherwise. For example, a reference to “an element” is a reference to one or more elements and includes all equivalents known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Language that may be construed to express approximation should be so understood unless the context clearly dictates otherwise.

Unless defined otherwise, all technical and scientific terms used herein have the same meanings as commonly understood by a person of ordinary skill in the art to which this invention belongs. Preferred methods, techniques, devices, and materials are described. But any methods, techniques, devices, or materials similar or equivalent to those described herein may be used in the practice or testing of the present invention. Structures described herein should also be understood to refer to functional equivalents of such structures.

“Combustion” or “burning” is generally defined as a high-temperature exothermic redox chemical reaction between a fuel (the reductant) and an oxidant, usually atmospheric oxygen, that produces oxidized, often gaseous products, in a mixture generally referred to as smoke, where incomplete combustion produces more smoke. Combustion in a fire produces a flame, and the heat produced from the flame can make combustion self-sustaining. Combustion is often a complicated sequence of elementary radical reactions. Solid fuels, such as wood and coal, first undergo endothermic pyrolysis to produce gaseous fuels whose combustion then supplies the heat required to produce more of them. Combustion is often hot enough that polychromatic light in the form of either glowing or a flame is produced.

A “bayonet mount” is a fastening mechanism consisting of a cylindrical male side with one or more radial pins, and a female receptor with one or more matching L-shaped slots and/or with spring(s) to keep the two parts locked together. The slots are shaped like a capital letter L with a serif (a short upward segment at the end of the horizontal arm). In a bayonet mount, the pin slides into the vertical arm of the L, rotates across the horizontal arm. In more specialized bayonet mounts, the pin is then pushed slightly upwards into the short vertical “serif” by a spring mechanism, the connector no longer free to rotate unless pushed down against the spring until the pin is out of the “serif.”

“Powder coating” is a type of coating that is applied as a free-flowing, dry powder. The main difference between a conventional liquid paint and a powder coating is that the powder coating does not require a solvent to keep the binder and filler parts in coating and is then cured under heat to allow it to flow and form a “skin.” In general, the powder may be a thermoplastic or a thermoset polymer. It is usually used to create a hard finish that is tougher and more heat resistant than conventional paint.

“Thermal barrier coatings” are advanced materials systems usually applied to metallic surfaces, such as on gas turbine or engine parts, operating at elevated temperatures, as a form of exhaust heat management. These relatively thin coatings serve to insulate components from large and prolonged heat loads by utilizing thermally insulating materials which can sustain an appreciable temperature difference between the load-bearing alloys and the coating surface. In doing so, these coatings can allow for higher operating temperatures while limiting the thermal exposure of structural components, extending part life by reducing oxidation and thermal fatigue. In the context of this application, a thermal barrier may generally be referred to as a ceramic coating.

References to “one embodiment,” “an embodiment,” “various embodiments,” etc., may indicate that the embodiment(s) of the invention so described may include particular features, structures, or characteristics. However, not every embodiment necessarily includes the particular features, structures, or characteristics. Further, repeated use of the phrase “in one embodiment,” or “in an exemplary embodiment,” do not necessarily refer to the same embodiment although they may. A description of an embodiment with several components in communication with each other does not imply that all such components are required. On the contrary, a variety of optional components are described to illustrate the wide variety of possible embodiments of the present invention.

As is well known to those skilled in the art, many careful considerations and compromises typically must be made when designing for the optimal manufacture of a commercial implementation of a collapsible smoke minimizing fire pit. A commercial implementation in accordance with the spirit and teachings of the invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art.

The exemplary smoke minimizing fire pit will now be described in detail with reference to embodiments thereof as illustrated in the accompanying drawings.

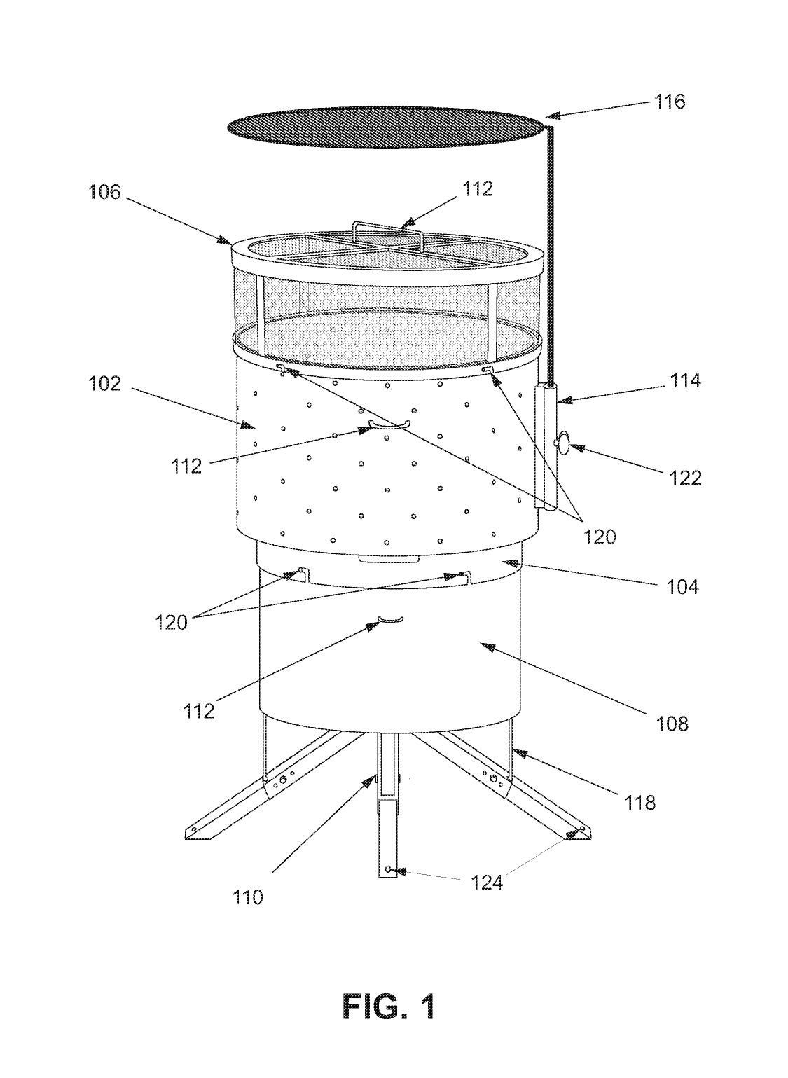

FIG. 1 is a perspective view of a fully assembled smoke minimizing fire pit in accordance with an embodiment of the invention. In the preferred embodiment of the invention, the parts which comprise the smoke minimizing fire pit are made of a heat and corrosion resistant metal or metal alloy such as, but not limited to, steel or stainless steel. Embodiments of the invention may come in multiple sizes and may employ differing shapes and configurations of each component. The exemplary smoke minimizing fire pit consists of a combustion barrel 102, a mounting ring 104, a locking lid with ash screen 106, an insulated ash container with a heat shield 108, a folding leg assembly with stake holes 110, handles for the major components 112, and a component mount 114 for adding on components such as, but not limited to, a height-adjustable grill 116. In the preferred embodiment of the invention, the component mount 114 is essentially a metal tube which may accept a sliding rod attached to a grill component and is held in place by a simple screw mechanism 122.

The combustion barrel 102 is, in general, cylindrically shaped with a plurality of small apertures in the side wall. The apertures in the side walls allow for air to pass through and facilitate combustion while still providing a windbreak when starting a fire and an effective barrier to prevent embers from flying off. The number of apertures may depend on the size of the combustion barrel. For example, but not limitation, a larger combustion barrel may require more apertures to allow more air to enter. In embodiments of the invention, the apertures may be spaced apart in differing patterns so as to create different airflow patterns. In embodiments of the invention, one end of the combustion barrel is an opening with the other end of the combustion barrel consisting of a funnel shaped ash channel and metal grate which allows for ashes to slide into the insulated ash container without clogging air vents or passages. In alternative embodiments of the invention, the width of the apertures may vary or may be custom created to suit differing user needs. In the preferred embodiment of the invention, the combustion barrel may be made from a heat and corrosion resistant metal alloy such as stainless steel. However, in alternative embodiments of the invention, a thermal barrier coating such as, but not limited to, a ceramic may be applied for greater thermal and corrosion resistance. At the base of the combustion barrel is an attachment ring 104 which is connectible to the insulated ash container with heat shield 108.

The insulated ash container with heat shield 108 is cylinder shaped and may attach to the attachment ring 104 of the combustion barrel 102. In the preferred embodiment of the invention, the components attach to one another by a bayonet mount mechanism. However, persons skilled in the art will readily appreciate that there are numerous means known in the art which may be used to attach the components to one another. Attached to the base of the insulated ash container with heat shield is a folding leg assembly 110. In the preferred embodiment of the invention, each the folding legs consists of two steel struts hingedly attached to each other and may be held in place by one of many locking mechanisms known and appreciated in the art. The folding leg assembly 110 may assume differing widths and angles as well. Stake holes 124 may be added as an additional safety feature to the distal ends of each folding leg so as to provide for additional stability in preventing the collapsible smoke minimizing fire pit from falling over.

The locking lid with ash screen 106 is designed to minimize the ejection of dangerous embers being thrown off a fire during combustion. In the preferred embodiment of the invention the locking lid is a metal frame with a metal grating secured to the metal frame. The locking lid with ash screen attaches to the open end of the combustion barrel 102 and is secured through a bayonet mount mechanism. Persons skilled in the art will readily appreciate that numerous locking lid with ash screen designs may be employed in conjunction with a collapsible smoke minimizing fire pit.

In the preferred embodiment of the invention, handles 112 are attached to the locking lid with ash screen 106, the combustion barrel 102 and to the insulated ash container with heat shield 108. Persons skilled in the art will readily appreciate that such handles may be attached by, but not limited to, welding, riveting, or by a screw and bolt mechanism. The handles are mounted on the top of the locking lid with ash screen 106 and on the outer perimeters of the combustion barrel 102 and insulated ash container with heat shield 108 are positioned diametrically opposite of one another.

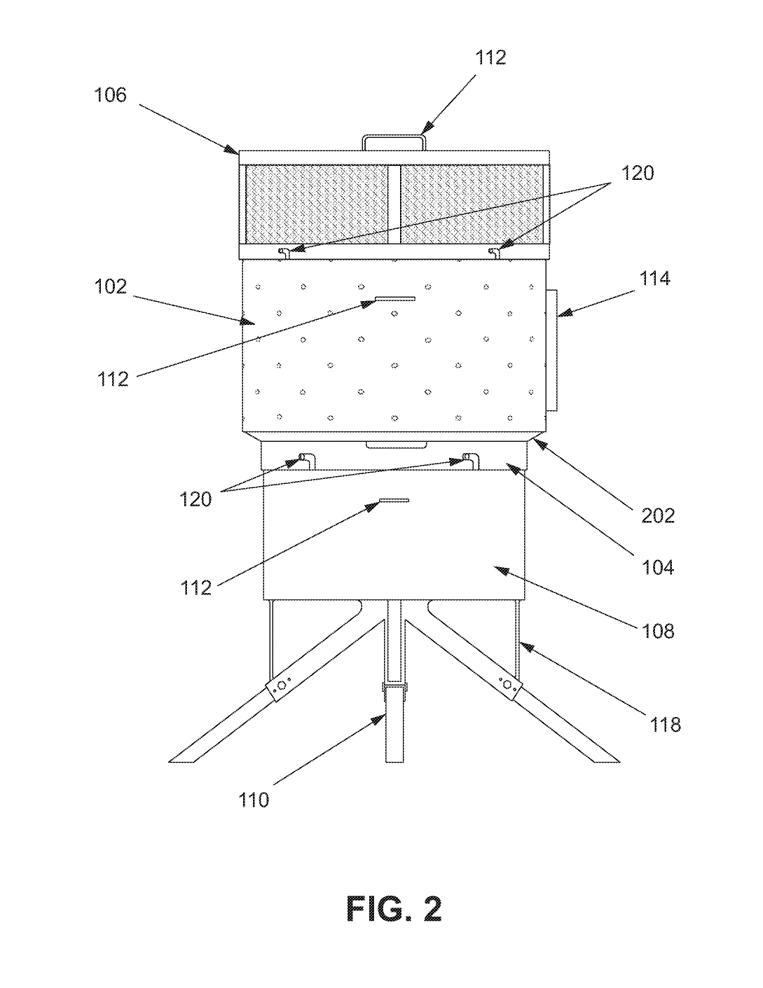

FIG. 2 is a side elevation view of the smoke minimizing fire pit in accordance with an embodiment of the invention. In this view, the component mount 114 for adding on components such as, but not limited to, a height-adjustable grill (as depicted in FIG. 1) attached longitudinally to the combustion barrel 102. In the preferred embodiment of the invention, the component mount 114 is essentially a metal tube which may accept a sliding rod attached to a grill component and is held in place by a nut and bolt mechanism. Alternative embodiments may include tube clamp which may accept a sliding rod attached to various grill components.

Attached at the base of the combustion barrel 102 is a mounting ring 104. The base of the combustion barrel 202 is funnel shaped with the mounting ring 104 attached to the base. Persons skilled in the art will understand that the mounting ring 104 may be welded to the base of the combustion barrel through numerous means known and appreciated in the art. The mounting ring 104 connects to the insulated ash container with heat shield 108.

In the preferred embodiment of the invention, the locking lid with ash screen 106, combustion barrel 102 and mounting ring 104, and insulated ash container with heat shield 108 components are detachably fastened together by a bayonet mount mechanism 120. However, numerous other means of fastening the components are available such as, but not limited to, as screw mechanism or a simple slide on mechanism.

A folding leg assembly 110 is attached to the insulated ash container with heat shield 108. In the preferred embodiment of the invention, the folding leg assembly consists of four folding legs which are permanently attached to the base of the insulated ash container with heat shield 108. In alternative embodiments of the invention, the folding leg assembly may consist of at least three folding legs attached to the outside of the insulated ash container. It will become readily apparent to persons having skill in the art that there are numerous ways of creating a folding leg assembly attachable to the outside of the insulated ash container, and the preferred embodiment of the invention in no way is meant to limit the means and methods of creating and attaching such a folding leg assembly. Persons having skill in the art will understand also that a folding leg assembly 110 may be attached through numerous welding techniques. The folding leg assembly may be further supported by the use of brackets 118 connecting each leg of the folding leg assembly 110 to the base of the insulated ash container with heat shield 108. Stake holes may be added as an additional safety feature to the distal ends of each folding leg so as to provide for additional stability and security in preventing the collapsible smoke minimizing fire pit from falling over. However, in alternative embodiments, the folding leg assembly may be removably attached to a mounting bracket through a simple screw and bolt mechanism. The size and width of the folding leg assembly 110 may vary according to user needs as well. Persons having skill in the art will readily appreciate that the legs of the folding leg assembly 110 may fold through one of many locking hinge mechanisms known and understood in the art which holds the legs in place when the legs are extended and allows for folding when a user wishes.

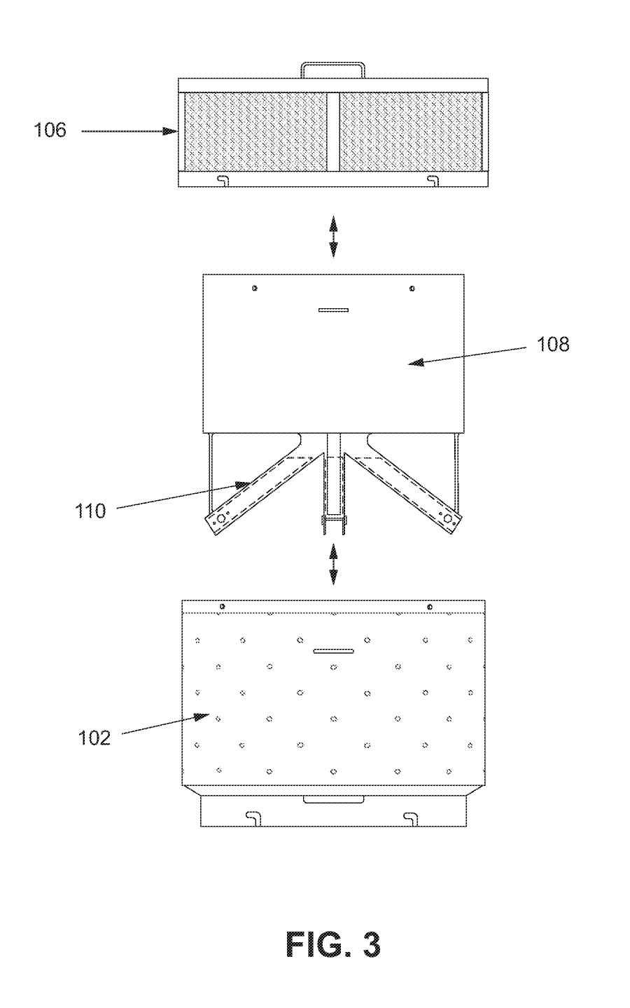

FIG. 3 is a side exploded view of a collapsible smoke minimizing fire pit in accordance with an embodiment of the invention. The insulated ash container with heat shield 108 is pictured with the folding leg assembly 110 with legs folded inward. With the legs folded inward, the insulated ash container 108 with heat shield may fit securely inside the combustion barrel 102. The locking lid with ash screen 106 may then be attached to the combustion barrel to create a collapsed and more transportable fire pit. In the preferred embodiment of the invention, a bayonet mount mechanism is used to attach the components. However, persons having skill in the art will understand that numerous other attachment mechanisms known and understood in the art may be used.

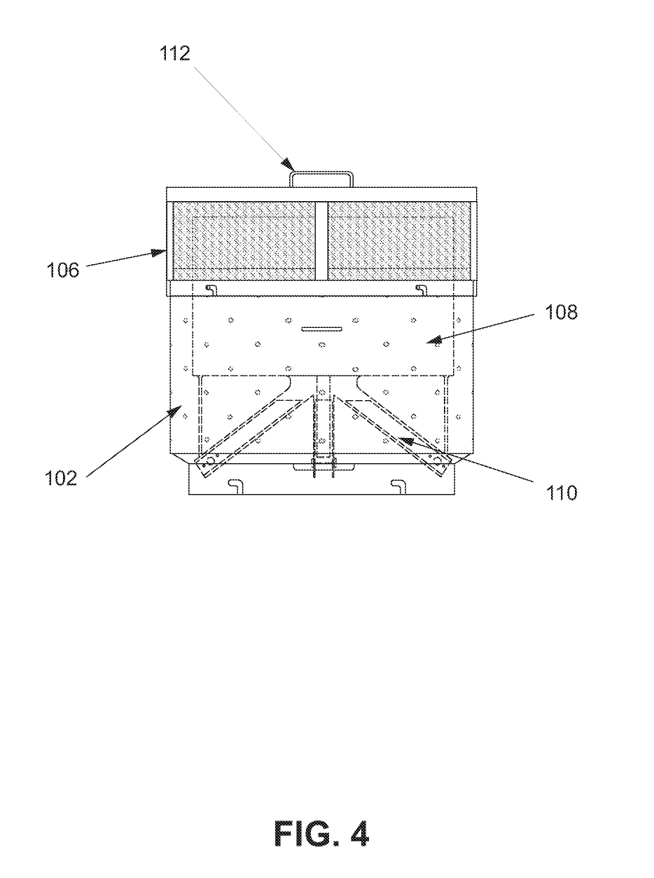

FIG. 4 is a side view of a collapsed smoke minimizing fire pit in accordance with an embodiment of the invention. In this illustration, the insulated ash container with heat shield 108 is nestled inside the combustion barrel 102 and is represented by dashed lines. The legs of the folding leg assembly 110 have been folded inwards so as to collapse the insulated ash container with heat shield 108. Persons having skill in the art will readily appreciate that the legs of the folding leg assembly 110 may fold through one of many locking hinge mechanisms known and understood in the art which holds the legs in place when the legs are extended and allows for folding when a user wishes. Persons skilled in the art will further appreciate that there are numerous ways to secure the insulated ash container with heat shield when stored inside the combustion barrel. A handle 112 on top of the locking lid with ash screen 106 may allow a user to easily carry the collapsed fire pit from one location to another.

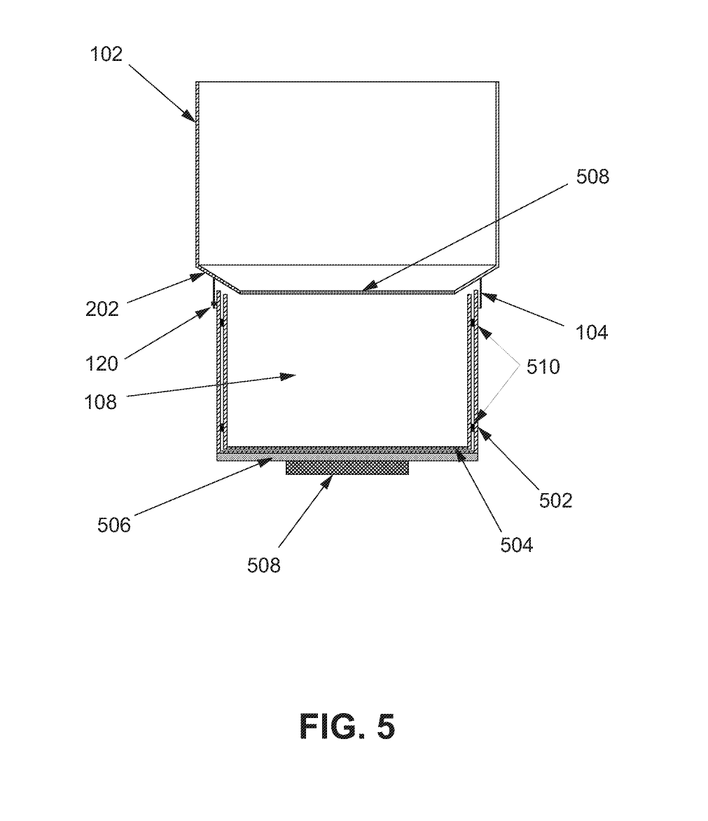

FIG. 5 is a side cross sectional view of the combustion barrel and insulated ash container with heat shield of a collapsible smoke minimizing fire pit in accordance with an embodiment of the invention. In this view, the combustion barrel 102 is attached to the insulated ash container 108 with heat shield through the use of a mounting ring 104. The mounting ring 104 has the female end of a bayonet mount 120 whereas the insulated ash container 108 employs the male end. In the preferred embodiment of the invention, three bayonet mounts are used and are spaced apart equally along the circumference of the components employing the mounts.

The base of the combustion barrel 202 is funnel shaped with a metal grate 508 closing off the narrow end of the funnel. Persons skilled in the art will recognize that differing angles and lengths of the base end of the combustion barrel 202 may be achieved. The metal grate 508 serves a dual purpose in both allowing ashes and combustion byproducts to fall into the insulated ash container with heat shield 108 and allowing air to flow upward through the metal grate 508 and to the combustible material resting on the metal grate 508. Apertures in the mounting ring 104 allow for air to flow through the mounting ring and around the funnel shaped base end 202 and up through the metal grate. The mounting ring 104 may assume differing widths, diameters and heights to allow for varying shapes of the combustion barrel 102 and insulated ash container with heat shield 108. Persons skilled in the art will appreciate that numerous means of providing for spark and ember reduction such as, but not limited to, spark arrestor screens may be incorporated into the mounting ring as well.

The insulated ash container consists of two concentric cylinders, an outer cylinder 502 and an inner cylinder 504 which may be attached together by various attachment means to create an insulated container such as, but not limited to, metal welds 510. Such a configuration forms a double-walled insulated ash container. An additional heat shield 506 may be attached to the base end. Persons skilled in the art will recognize that the insulated ash container may allow for water to be added to the container as an additional safety feature for ashes to fall into water as well as additional weight directed towards the base of the collapsible smoke minimizing fire pit. In addition, a mounting bracket 508 for the folding leg assembly may be attached to the base of the insulated ash container 108. Persons having skill in the art will readily appreciate that an attachable folding leg assembly may be connected to the mounting bracket 508 by various means known and appreciated in the art such as, but not limited to, welding or a traditional nut and bolt mounting mechanism.

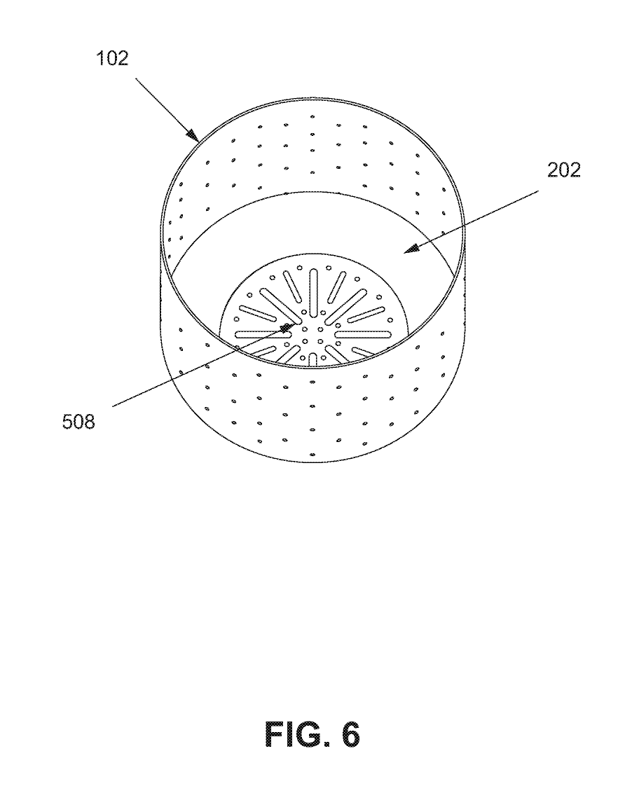

FIG. 6 is a top perspective view of the combustion barrel of the collapsible smoke minimizing fire pit in accordance with an embodiment of the invention. In this view, the handles and bayonet mount lugs are not shown for convenience and ease of understanding. At the base of the funnel-shaped ash channel 104 is a metal grate 508 which may serve as a fuel holder. In the preferred embodiment of the invention, the metal grate 508 consists of a slotted disc which contains a plurality of slots and apertures which allow air to flow upward and combustion products to flow through the slots and apertures into the insulated ash container. Persons skilled in the art will readily appreciate that the metal grate may be made from a suitable heat-resistant metal or metal alloy with its apertures being chosen from numerous patterns. In embodiments of the invention, the metal grate 508 may be removable and replaceable.

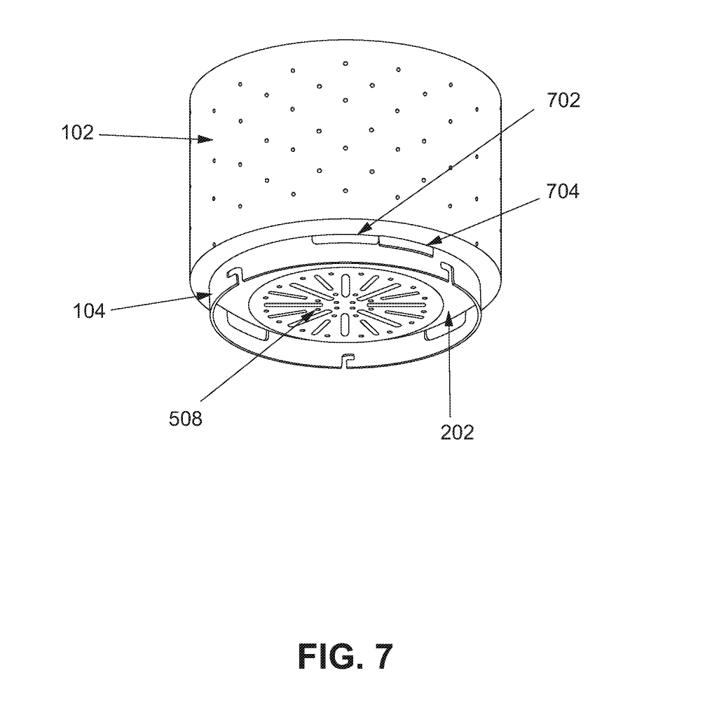

FIG. 7 is a bottom perspective view of the combustion barrel of the smoke minimizing fire pit in accordance with an embodiment of the invention. In this view, the handles and bayonet mount pins are not shown for convenience and ease of understanding. Pictured are three air passages 602 formed by spaces created in the mounting ring 104 and the funnel-shaped ash channel 202. In alternative embodiments, more passages may be employed. In some embodiments, a slideable damper system 704 may be used to restrict and/or control air from flowing through the passages. Persons skilled in the art will understand that damper systems are known in the art and are readily configurable to the collapsible smoke minimizing fire pit. The use of dampers in conjunction with air passages may allow for more or less air to travel inwards and upwards past the funnel shaped ash channel to facilitate more efficient combustion. The mounting ring 104 may assume differing widths, diameters and heights to allow for varying shapes of the combustion barrel 102 and insulated ash container with heat shield. Moreover, the mounting ring may also assume differing shapes to provide for a spark arrestor screen or serve as a spark or ember reducing screen itself.

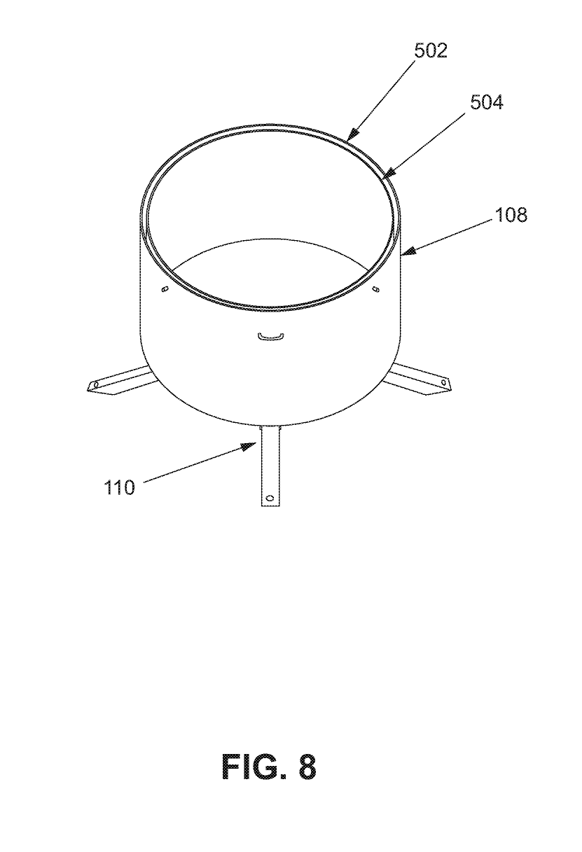

FIG. 8 is a perspective view of the insulated ash container with a heat shield 108 of the smoke minimizing fire pit in accordance with an embodiment of the invention. The insulated ash container consists of two concentric cylinders, an outer cylinder 502 and an inner cylinder 504 which may be sealed to create an insulated container. In various embodiments of the invention, the concentric cylinders may be connected by metal welds. In alternative embodiments, the cylinders may be connected by bolts. Ashes and other combustion byproducts are collected in the container 108 and may be disposed of after a fire has consumed all available fuel. In embodiments of the invention, the insulated ash container with heat shield 108 may be powder coated or painted to provide a better appearance as well as provide for extra insulation. Such an insulated ash container serves to protect surfaces such as lawns, patio decks and even frozen lakes from the heat generated by the smoke minimizing fire pit when in use. Persons skilled in the art will recognize that the insulated ash container may allow for water to be added to the container as an additional safety feature for ashes and embers to fall into the water as well as providing additional weight directed towards the base of the collapsible smoke minimizing fire pit. Users may easily extinguish a fire by simply pouring water over burning material which will ultimately collect in the insulated ash container. For safety purposes, a user may then detach the insulated ash container, stir the liquid mixture for an ample amount of time and then safely empty the liquid in a suitable location. Such a safety feature makes the smoke minimizing fire pit suitable for camping and recreation in places such as public spaces, public forest and public events.

Use of the exemplary collapsible smoke minimizing fire pit is designed to be as simple as possible. The collapsible smoke minimizing fire pit provides a space in which fuel is placed, ignited and allowed to burn. The air passages and apertures allow for an efficient air and fuel mixture so as to facilitate complete combustion, thereby minimizing smoke and the throwing off of dangerous embers. The combustion barrel is easily detachable from the insulated ash container with heat shield. The folding leg assembly allows for the legs to be folded up with the insulated ash container then being able to be placed in the combustion barrel and the lid then attachable to the combustion barrel. A handle on top of the lid then allows a user to easily carry the collapsed fire pit from one location to another.

All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Having fully described at least one embodiment of the exemplary collapsible smoke minimizing fire pit, other equivalent or alternative methods of implementing the collapsible smoke minimizing fire pit according to the present invention will be apparent to those skilled in the art. Various aspects of the invention have been described above by way of illustration, and the specific embodiments disclosed are not intended to limit the invention to the particular forms disclosed. The particular implementation of the collapsible smoke minimizing fire pit may vary depending upon the particular context or application. By way of example, and not limitation, the collapsible smoke minimizing fire pit described in the foregoing was principally directed to recreational fire pits. However, similar techniques may instead be applied to other applications such as commercial macroscale fire pits or recreational vehicle applications, which implementations of the present invention are contemplated as within the scope of the present invention. The invention is thus to cover all modifications, equivalents, and alternatives falling within the spirit and scope of the following claims. It is to be further understood that not all of the disclosed embodiments in the foregoing specification will necessarily satisfy or achieve each of the objects, advantages, or improvements described in the foregoing specification.

Although specific features of the invention are shown in some drawings and not others, persons skilled in the art will understand that this is for convenience. Each feature may be combined with any or all of the other features in accordance with the invention. The words “including,” “comprising,” “having,” and “with” as used herein are to be interpreted broadly and comprehensively, and are not limited to any physical interconnection. Claim elements and steps herein may have been numbered and/or lettered solely as an aid in readability and understanding. Any such numbering and lettering in itself is not intended to and should not be taken to indicate the ordering of elements and/or steps in the claims to be added at a later date.

Any amendment presented during the prosecution of the application for this patent is not a disclaimer of any claim element presented in the description or claims to be filed. Persons skilled in the art cannot reasonably be expected to draft a claim that would literally encompass each and every equivalent.

What is claimed is:

1. A collapsible smoke minimizing fire pit comprising:
a combustion barrel with an open end and a base end;
a locking lid with ash screen;
an insulated ash container with heat shield;
a folding leg assembly; and
a component mount.

2. The collapsible smoke minimizing fire pit of claim 1 wherein the combustion barrel may include a plurality of apertures in the side wall of the said combustion barrel.

3. The collapsible smoke minimizing fire pit of claim 1 wherein the base end consists of a funnel-shaped ash channel and a metal grate.

4. The collapsible smoke minimizing fire pit of claim 1 wherein a mounting ring is attached to the base end of the combustion barrel.

5. The collapsible smoke minimizing fire pit of claim 1 wherein apertures are located in the mounting ring so as to provide airflow through the base end of the combustion barrel.

6. The collapsible smoke minimizing fire pit of claim 1 wherein the locking lid with ash screen may be removably attached to the combustion barrel.

7. The collapsible smoke minimizing fire pit of claim 1 wherein the insulated ash container with heat shield consists of an open end and a closed end made of two concentric cylinder units with one closed end connected together in such a way so as to create an insulated container.

8. The collapsible smoke minimizing fire pit of claim 1 wherein the folding leg assembly consists of at least three folding legs which may fold in a manner so as to allow the insulated ash container to fit inside the combustion barrel.

9. The collapsible smoke minimizing fire pit of claim 1 wherein the folding leg assembly may attach to the outside of the insulated ash container.

10. The collapsible smoke minimizing fire pit of claim 4 wherein the insulated ash container with heat shield may attach to the mounting ring attached to the combustion barrel.

11. A collapsible smoke minimizing fire pit comprising:
a combustion barrel with an open end and a funnel-shaped base end with an attachable metal grate forming the said base end of the said combustion barrel;
a locking lid with ash screen;
a double-walled insulated ash container with heat shield;
a folding leg assembly; and
a component mount.

12. The collapsible smoke minimizing fire pit of claim 11 wherein the combustion barrel may include a plurality of apertures in the side wall of the said combustion barrel.

13. The collapsible smoke minimizing fire pit of claim 11 wherein a mounting ring is attached to the base end of the combustion barrel.

14. The collapsible smoke minimizing fire pit of claim 11 wherein apertures and a damper system are located in the mounting ring so as to provide airflow through the base end of the combustion barrel.

15. The collapsible smoke minimizing fire pit of claim 11 wherein the locking lid with ash screen may be removably attached to the combustion barrel.

16. The collapsible smoke minimizing fire pit of claim 11 wherein the double-walled insulated ash container with heat shield consists of two concentric cylinder units with one closed end connected together in such a way so as to create an insulated container.

17. The collapsible smoke minimizing fire pit of claim 11 wherein the folding leg assembly may attach to a mounting bracket attached to the bottom of the said double-walled insulated ash container with heat shield.

18. The collapsible smoke minimizing fire pit of claim 11 wherein the folding leg assembly consists of four folding legs which may fold in a manner so as to allow the insulated ash container to fit inside the combustion barrel.

19. The collapsible smoke minimizing fire pit of claim 16 wherein the double-walled insulated ash container with heat shield may attach to the mounting ring attached to the combustion barrel.

20. A collapsible smoke minimizing fire pit comprising:
a combustion barrel with an open end and a funnel-shaped base end with a mounting ring attached to the funnel shaped base end and a metal grate removably attached to the said base end of the said combustion barrel, the said combustion barrel having a plurality of apertures in the sidewall;
a locking lid with ash screen removably attachable to the open end of the said combustion barrel;
a double-walled insulated ash container with heat shield removably attachable to the mounting ring attached to the funnel shaped base end of the said combustion barrel with a folding leg assembly mounted to the bottom of the said insulated ash container with heat shield; and
a component mount longitudinally attached to the said combustion barrel.
